(19) United States
(12) Patent Application Publication
(10) Pub. No.: US 2021/0394990 A1
(43) Pub. Date: Dec. 23, 2021

(54) SOUS VIDE POUCH, ASSEMBLY, SYSTEM AND METHOD

(71) Applicant: BREVILLE USA, INC., Torrance, CA (US)

(72) Inventors: Christopher Charles Young, Seattle, WA (US); Charles M. Shaw, Torrance, CA (US)

(21) Appl. No.: 17/280,087

(22) PCT Filed: Sep. 27, 2019
(86) PCT No.: PCT/IB2019/058210

§ 371 Date: Mar. 25, 2021

Related U.S. Application Data
(60) Provisional application No. 62/738,786, filed on Sep. 28, 2018.

(51) Int. Cl. B65D 81/34; A47J 27/10; B65D 81/20; B65D 81/32; B65D 33/00; B65D 33/16; B65D 75/58

(52) U.S. Cl. CPC B65D 81/3415; A47J 27/10; B65D 81/2038; B65D 75/5805; B65D 33/004; B65D 33/1666; B65D 81/3266

(57) ABSTRACT

Pouches and assemblies for use in sous vide cooking, and associated systems and methods are disclosed. In several embodiments, a sous vide pouch includes a sealable chamber having a sauce for cooking with a food product. The chamber can have a partition that provides a boundary a boundary between a first and second portion of the chamber to receive two food products during a sous vide cooking process. In some embodiments, the sous vide pouch can further include a vacuum valve for removing air from the chamber.

### RELATED APPLICATIONS

The current application claims priority from U.S. provisional application 62/738,786, filed on Sep. 28, 2018, the content of which is hereby incorporated by reference in its entirety.

### TECHNICAL FIELD

The present invention relates to sous vide cooking. Particular aspects relate to a sous vide pouch, a sous vide pouch assembly, a method of use of the sous vide pouch and sous vide assembly, and systems and method for tracking sous vide pouches.

### BACKGROUND

Sous vide is a method of cooking in which food is placed in a plastic pouch, glass jar, or other sealed container and cooked in a water bath or steam environment for longer than normal cooking times (e.g., 1-7 hours or more) at an accurately regulated temperature. The temperature can be much lower than normally used for cooking, typically around 55-75° C. (131-167° F.) for meat and somewhat higher for vegetables, typically around 82-95° C. (180-203° F.). The intent is to cook the item evenly, with little risk of under- or over-cooking, while achieving textural, nutritional, and flavor benefits. Sometimes sauces or other ingredient preparations can be placed in the sealed container with the food to be cooked.

A problem faced with sous vide cooking is that multiple food products placed in a sous vide pouch may overlap and/or contact each other during the sous vide cooking process. This can decrease the surface area of the food products which are exposed during the sous vide cooking process which can decrease the effectiveness and predictability of the sous vide cooking process.

Another problem faced is the preparation time and the difficulty with preparing a sauce which is to be contained in the sous vide pouch. The sauce needs to be prepared in a manner to accommodate liquid that may exude from the food product(s) during the sous vide cooking process. Once the sauce has been prepared, the sauce needs to be poured into the plastic sous vide pouch which can be difficult due to the flexible nature of the pouch, thereby resulting in some spillage. As the sauce may have been prepared to accommodate liquid which exudes from the food product, the reduced amount of sauce which is poured into the sous vide pouch may result in an undesired food product and sauce after the sous vide cooking process.

### SUMMARY

It is an object of the present invention to at least substantially address one or more of the above disadvantages, or at least provide a useful alternative to the above discussed arrangements and/or methods.

In a first aspect there is provided a sous vide pouch, comprising: a plastic material having a sealed portion extending at least partially around a perimeter of the plastic material and defining a chamber; and a partition extending within at least a portion of the chamber forming a boundary between a first portion and a second portion of the chamber, wherein the first and second portions are each configured to receive a food product therein.

In certain embodiments, the sous vide pouch comprises a tearable portion and a resealable opening of the chamber, wherein the resealable opening of the chamber is accessible by tearing of the tearable portion.

In certain embodiments, the chamber contains a sauce prior to the tearing of the tearable portion.

In certain embodiments, the sauce includes at least one of: a liquid; and a gel.

In certain embodiments, the partition is: a weld between opposing wall portions of the chamber; or a seal between the opposing wall portions of the chamber.

In certain embodiments, the seal is an adhesive seal.

In certain embodiments, the partition is frangible to remove the boundary between the first and second portions.

In certain embodiments, the sous vide pouch comprises a valve to facilitate removal of air from the chamber.

In certain embodiments, the valve is a one-way valve.

In certain embodiments, at least some of the plastic material of the chamber is textured to create channels for the air to flow therethrough toward the valve during removal of the air.

In certain embodiments, the at least some of the plastic material of the chamber that is textured comprises: an embossed texture; a waffled texture; or a castellated texture.

In certain embodiments, the valve includes a membrane configured to permit the air within the chamber to pass therethrough and inhibit non-gaseous contents within the chamber exiting via the valve.

In certain embodiments, the sous vide pouch includes a dam formation configured to inhibit the non-gaseous contents exiting the chamber via the valve during removal of the air.

In certain embodiments, the sous vide pouch comprises a removable lid for sealing the valve.

In certain embodiments, the sous vide pouch comprises a machine-readable code is printed or applied to an exterior surface of the sous vide pouch, wherein the machine-readable code is indicative of at least one of: a type of contents within the chamber; a batch number of the contents within the chamber; a manufacture date of the contents within the chamber; and a best-by date of the contents within the chamber.

In a second aspect, the is provided a sous vide pouch assembly, comprising: a sous vide pouch comprising a plastic material having a seal portion extending at least partially around a perimeter of the plastic material and defining a chamber; and a clip including a pair of fingers configured to clampingly engage about at least a portion of the plastic material forming a boundary between a first portion and a second portion of the chamber, wherein the first and second portions are each configured to receive a food product therein.

In certain embodiments, the pair of fingers are resiliently biased into clamping engagement about the at least a portion of the plastic material.

In certain embodiments, the clip includes a magnetic material for removably securing the sous vide pouch assembly to a base of a cooking vessel.

In certain embodiments, the sous vide pouch comprises a tearable portion and a resealable opening of the chamber, wherein the resealable opening of the chamber is accessible by tearing of the tearable portion.

In certain embodiments, the chamber contains a sauce prior to the tearing of the tearable portion.

In certain embodiments, the sauce includes at least one of: a liquid; and a gel.

In certain embodiments, the sous vide pouch comprises a valve to facilitate removal of air from the chamber.

In certain embodiments, the valve is a one-way valve.

In certain embodiments, at least some of the plastic material of the chamber is textured to create channels for the air to flow therethrough toward the valve during removal of the air.

In certain embodiments, the at least some of the plastic material of the chamber that is textured comprises: an embossed texture; a waffled texture; or a castellated texture.

In certain embodiments, the valve includes a membrane configured to permit the air within the chamber to pass therethrough and inhibit non-gaseous contents within the chamber exiting via the valve.

In certain embodiments, the sous vide pouch includes a dam formation configured to inhibit the non-gaseous contents exiting the chamber via the valve during removal of the air.

In certain embodiments, the sous vide pouch includes a removable lid for sealing the valve.

In certain embodiments, a machine-readable code is printed or applied to an exterior surface of the sous vide pouch, wherein the machine-readable code is indicative of at least one of: a type of contents within the chamber; a batch number of the contents within the chamber; a manufacture date of the contents within the chamber; and a best-by date of the contents within the chamber.

In certain embodiments, the sous vide pouch includes a partition extending within at least a portion of the chamber forming a further boundary and a further portion of the chamber configured to receive a further food product therein.

In certain embodiments, the partition is: a weld between opposing wall portions of the chamber; or a seal between the opposing wall portions of the chamber.

In certain embodiments, the seal is an adhesive seal.

In certain embodiments, the partition is frangible to remove the further boundary.

In a third aspect there is provided a sous vide pouch, comprising: a plastic material having a seal portion extending at least partially around a perimeter of the plastic material and defining a chamber, wherein the chamber includes a resealable opening; a tearable portion inhibiting access to the resealable opening; and a valve to facilitate removal of at least some air from the chamber; wherein a sauce is contained within the chamber prior to tearing of the tearable portion; and wherein the chamber is configured to receive a food product therein prior to sealing of the resealable opening and removal of the at least some air from within the chamber.

In certain embodiments, the valve is a one-way valve.

In certain embodiments, at least some of the plastic material of the chamber is textured to create channels for the air to flow therethrough toward the valve during removal of the air.

In certain embodiments, the at least some of the plastic material of the chamber that is textured comprises: an embossed texture; a waffled texture; or a castellated texture.

In certain embodiments, the valve includes a membrane configured to permit the air within the chamber to pass therethrough and inhibit non-gaseous contents within the chamber exiting via the valve.

In certain embodiments, the sous vide pouch includes a dam formation configured to inhibit the non-gaseous contents exiting the chamber via the valve during removal of the air.

In certain embodiments, the sous vide pouch comprises a removable lid for sealing the valve.

In certain embodiments, the sous vide pouch comprises a machine-readable code which is printed or applied to an exterior surface of the sous vide pouch, wherein the machine-readable code is indicative of at least one of: a type of contents within the chamber; a batch number of the contents within the chamber; a manufacture date of the contents within the chamber; and a best-by date of the contents within the chamber.

In a further aspect there is provided a method of cooking using a sous vide pouch configured according to the first aspect, comprising: locating the food products in the first and second portions of the chamber for sealing; and locating the sous vide pouch in a cooking vessel.

In a further aspect there is provided a method of cooking using a sous vide pouch assembly configured according to the second aspect, comprising: coupling the clip in clamping engagement with the sous vide pouch; locating the food products in the first and second portions of the chamber for sealing; and locating the sous vide pouch in a cooking vessel.

In a further aspect there is provided a method of cooking using a sous vide pouch configured according to any one of claims 34 to 41, comprising: tearing the tearable portion; locating the food product in the chamber; sealing the resealable opening; removing at least some air from the chamber via the valve; and locating the sous vide pouch in a cooking vessel.

In a further aspect there is provided a system for tracking sous vide pouches, comprising: at least one processor; and at least one non-transitory processor-readable medium storing processor-executable instructions that, when executed by the at least one processor, cause the at least one processor to: receive data from at least one production facility about the sous vide pouches, the data including information about at least one of a type of sauce contained within the sous vide pouches, a retailer associated with the sous vide pouches, a best-by-date of the sous vide pouches, and a bundle associated with the sous vide pouches; receive, from at least one user device, a request for cooking instructions and/or recipe information associated with at least one of the sous vide pouches; and provide the cooking instructions and/or the recipe information to the at least one user device.

In certain embodiments, each sous vide pouch is configured according the first or third aspects.

In certain embodiments, each sous vide pouch is part of a sous vide assembly according to the second aspect.

Other aspects and embodiments are described herein.

### BRIEF DESCRIPTION OF THE DRAWINGS

Preferred embodiments of the present invention will now be described, by way of examples only, with reference to the accompanying drawings:

FIG. 1 is a front view of an example of a sous vide pouch in accordance with an embodiment of the present technology.

FIG. 2 is a front view of a further example of a sous vide pouch in accordance with another embodiment of the present technology.

FIG. 3A is a perspective view of an example removable clip in accordance with an embodiment of the present technology.

FIG. 3B is a front view of an example of a sous vide pouch assembly including the sous vide pouch shown in FIG. 2 with the clip shown in FIG. 3A coupled thereto.

FIG. 3C is a front view of an example of a sous vide pouch in accordance with another embodiment of the present technology.

FIG. 4 is a top view of an example of packaging for receiving and securing a sous vide pouch in accordance with an embodiment of the present technology.

FIG. 5 is a block diagram of an example of a suitable computer that may employ aspects of the present technology.

FIG. 6 is a block diagram of an example of a suitable computing environment in which aspects of the present technology may operate in a networked computer environment.

FIG. 7 is a block diagram of an example of a suitable system for tracking sous vide pouches via the present technology.

FIG. 8 is a flow diagram of an example of a suitable process or method for tracking sous vide pouches via the present technology.

FIG. 9 is a flow diagram of an example of a suitable process or method for cooking food products using the sous vide pouch of FIG. 1.

FIG. 10 is a flow diagram of an example of a suitable process or method for cooking food products using the sous vide pouch of FIG. 2.

FIG. 11 is a flow diagram of an example of a suitable process or method for cooking one or more food product using the sous vide pouch assembly of FIG. 3b.

### DETAILED DESCRIPTION

In the following detailed description, specific details are set forth to provide an understanding of the present technology. However, the present technology may be practiced without some of these specific details. In some instances, well-known structures and techniques have not been shown in detail so as not to obscure the present technology. The terminology used in the description presented below is intended to be interpreted in its broadest reasonable manner, even though it is being used in conjunction with a detailed description of certain specific embodiments of the disclosure. For example, while certain aspects of the operation of the systems and methods are described in the context of sous vide pouches, one skilled in the art will understand that the present technology is applicable to many different types of food products, cooking techniques, packaging technologies, etc. Certain terms may even be emphasized below; however, any terminology intended to be interpreted in any restricted manner will be overtly and specifically defined as such in this Detailed Description section.

Aspects of the present disclosure are directed generally toward a sous vide pouch. In some of the implementations described below, the sous vide pouch can hold or contain a pre-made sauce.

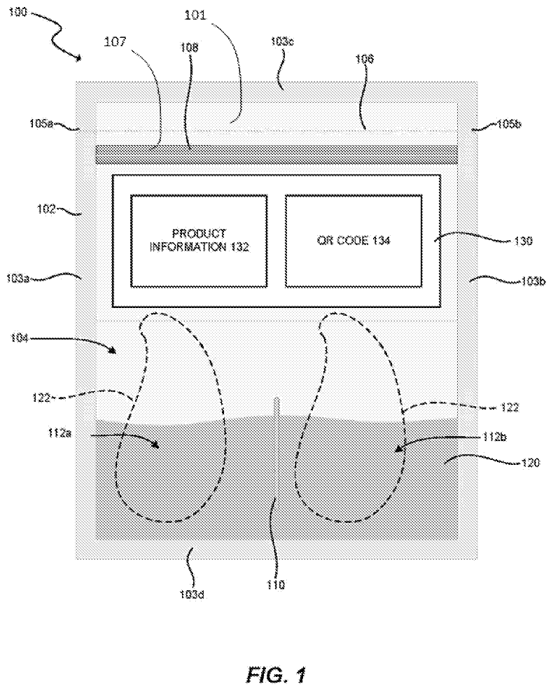

FIG. 1 is a front view of a sous vide bag or pouch 100 (“pouch 100”) in accordance with an embodiment of the present technology. In the illustrated embodiment, the pouch 100 includes an exterior weld or seal 102 defining an interior chamber 104. More specifically, the seal 102 includes a first side portion 103a, a second side portion 103b, a top portion 103c, and a bottom portion 103d. In some embodiments, the bottom portion 103d of the seal 102 can have a pillow construction, gusset, etc., such that the bottom portion 103d can be formed to, for example, allow the pouch 100 to be positioned on a surface in an upright, free-standing position. In the illustrated embodiment, the pouch 100 has a generally rectangular shape while, in other embodiments, the pouch 100 can have other shapes (e.g., circular, rectilinear, oval, polygonal, triangular, etc.).

The pouch 100 and the seal 102 can be formed from any material suitable for use at elevated temperatures for prolonged periods of time during a sous vide cooking process. For example, the pouch 100 can be formed from a polymer or laminated polymer film (e.g., oriented and bi-axially oriented films) including polypropylene (PP), cast PP, polyethylene (PE), low-density PE (LDPE), and/or linear LDPE (LLDPE). Additionally, the pouch 100 can include nylon films (e.g., for puncture resistance), retort grade films, non-retort grade films, foil laminates, non-foil laminates, etc. The material used to form the pouch 100 can further be selected to have high oxygen barrier properties (e.g., low transmission rates), high carbon dioxide barrier properties (e.g., low transmission rates), high moisture barrier properties (e.g., low transmission rates), to be tolerant to the pH of food within a selected range (e.g., 2-4 pH), etc. The seal 102 can be formed using a suitable heat-sealing, ultrasonic, and/or UV-curing process and can include a suitable adhesive, such as a low-migration lamination adhesive for use at elevated temperatures. In some embodiments, the pouch 100 and/or the seal 102 can include one or more perforations extending through one or more layers (e.g., laminate polymer layers) such that the pouch 100 has a desired permeability to specific gases, vapors, etc. In some embodiments, the pouch 100 can be recyclable and/or compostable. For example, the pouch 100 can be formed from polymers originating from bio-fermentation or crude-oil fractionation, or from recycled materials.

The first side portion 103a of the seal 102 can include a first notch (e.g., slit, groove, etc.) 105a extending at least partially therethrough, and the second side portion 103b can include a second notch 105b extending at least partially therethrough. The sous vide pouch includes a tearable portion 101. The pouch includes a resealable opening 107 of the chamber 104 which is accessible by tearing of the tearable portion 101. The pouch 100 includes a tear line (e.g., a laser perforation, a hot-needle perforation, etc.) 106 defining the tearable portion 101, wherein the tear line 106 extends between the notches 105 and a sealing member 108 of a resealable opening 107 configured to be operated by a user for sealing/unsealing the chamber 104 after the top portion 103c of the seal 102 is removed. The sealing member 108 of the resealable opening 107 of the chamber 104 can be a single-press zip seal, a multiple-press zip seal, or other sealing member known in the art. During use of the pouch 100, a user can grip the pouch 100 (e.g., proximate to at least one of the notches 105) and tear the pouch 100 along the tear line 106 to thereby remove the top portion 103c of the seal 102. The user can then unseal the sealing member 108 of the resealable opening 107 to enable access to the chamber 104. In the illustrated embodiment, a sauce 120 (e.g., a sauce for flavoring a food product during a sous vide cooking process) is disposed within the chamber 104. After removing the top portion 103c of the seal 102 and opening the sealing member 108, the user can position one or more food products 122 (shown schematically) within the chamber 104 and at least partially in the sauce 120. The food products 122 can be proteins (e.g., chicken, eggs, steak, fish, etc.), vegetables, or other food products suitable for sous vide cooking. The user can remove at least some air from the chamber 104 by, for example, squeezing the pouch 100 with the sealing member 108 partially open and subsequently closing the sealing member 108. In some embodiments, the pouch 100 can have a relatively small thickness (e.g., about 3 mm or less) such that the pouch 100 is flexible—which can provide for optimal (e.g., even and consistent) cooking.

In the illustrated embodiment, the pouch 100 further includes a partition 110 extending within at least a portion of the chamber 104 forming a boundary between a first portion 112a and a second portion 112b of the chamber 104, wherein the first and second portions 112a, b are each configured to receive a food product 122 therein. The partition extends generally parallel to the first and second side portions 103a, b thereby dividing or separating the chamber 104 into the first portion 112a and the second portion 112b. In some embodiments, the partition 110 can be positioned generally centrally with respect to the first and second side portions 103a, b while, in other embodiments, the partition 110 can be positioned closer to the one of the first and second side portions 103a, b such that the portions 112 of the chamber 104 have dissimilar dimensions (e.g., volumes). The partition 110 can be a weld or seal between opposing wall portions of the chamber 104 and, in one example, can have a length of about 70 mm and a width of about 2 mm. In some embodiments, the partition 110 can be an adhesive seal formed from a food safe adhesive that is peelable and/or re-sealable, and/or that can be activated by heat and pressure applied to the sealing surface. As shown, the partition 110 does not extend to the bottom portion 103d of the seal 102 to permit the sauce 120 to equalize between the first and second portions 112a, b of the chamber 104.

The partition 110 can be frangible such that the user can break or tear the partition 110 to remove the boundary between the first and second portions 112 a, b and join the portions 112 of the chamber 104. As shown, during use of the pouch 100, one of the food products 122 can be positioned within the first portion 112a of the chamber 104, and one of the food products 122 can be positioned within the second portion 112b of the chamber 104. The partition 110 can inhibit or prevent the food products 122 (e.g., two proteins) from overlapping and/or contacting each other during a sous vide cooking process. This can increase the surface area of the food products 122 exposed during the sous vide cooking process, and is expected to increase the effectiveness and predictability of the sous vide cooking process. In embodiments where the partition 110 is frangible, re-sealable, etc., the user can break or unseal the partition 110 to provide space within the chamber 104 for cooking a single, large food product 122 (e.g., a large steak). In some embodiments, the chamber 104 can include additional portions (e.g., chambers) separated by seals that are frangible, re-sealable, etc., to permit components (e.g., ingredients) to be initially separated and then selectively added to the chamber including the food products 122 during a sous vide cooking process.

A sticker 130 can be affixed to the pouch 100 and can include printed information such as product information 132 and machine readable code such as a QR code 134 or other unique identifier. The product information 132 can include, for example, a type (i.e. name and description) of the sauce 120, refrigeration instructions, cooking instructions, the lot/batch number of the sauce, the manufacture date of the sauce, the best-by date of the sauce, etc. As described in greater detail below, the QR code 134 can be scannable by a user device (e.g., an application running on a mobile phone or tablet). After scanning the QR code 134, the user device can receive, for example, cooking instructions, information about the sauce 120, information about particular food products to pair with the sauce 120, expiration or best-by date information, recall information, etc. Alternatively, the sticker 130 can be omitted and the product information 132 and/or QR code 134 can be printed directly on the pouch 100 using for example, a low migration ink intended for use at elevated temperatures. Further, the pouch 100 can include an RFID tag or similar passive or active data storage device instead of or in addition to the QR code 134.

In several of the embodiments described below, a system is configured to track the sous vide pouches by receiving data from (i) production and shipping facilities and (ii) multiple user devices (e.g., via an application running on mobile phones) after a user scans one of the QR codes. The system can further be configured to provide personalized food recommendations, cooking instructions, notifications, etc., to the user devices (e.g., via the application running on the mobile phones).

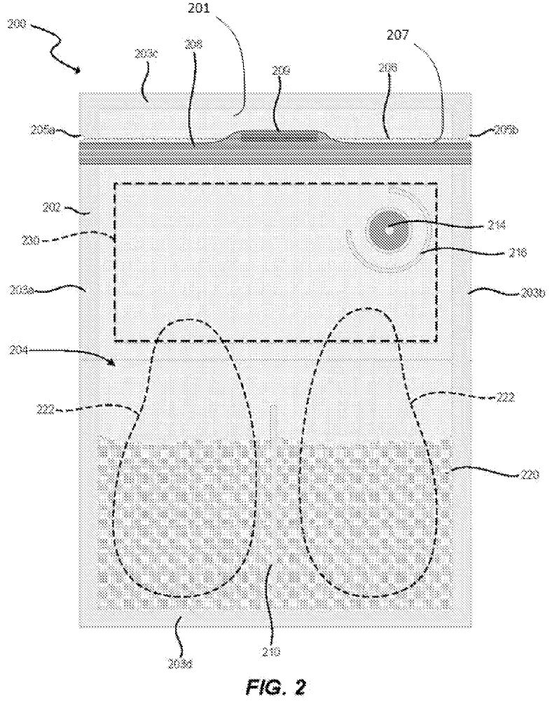

FIG. 2 is a front view of a sous vide bag or pouch 200 (“pouch 200”) in accordance with another embodiment of the present technology. Features of the sous vide pouch 200 that are identical or substantially similar to those of the sous vide pouch 100 are provided with a reference number increased by 100. It will be appreciated that the above description of these features in relation to the sous vide pouch 100 are also applicable to the corresponding identical features found in the sous vide pouch 200.

The pouch 200 includes several features generally similar to the features of the pouch 100 described in detail above with reference to FIG. 1. For example, the pouch 200 includes an exterior weld or seal 202 having a first side portion 203a, a second side portion 203b, a top portion 203c, and a bottom portion 203d, and defining an interior chamber 204. Likewise, the pouch 200 includes (i) a tearable portion 201 defined by a tear line 206 extending between a first notch 205a and a second notch 205b, (ii) a sealing member 208 configured to be operated by a user for sealing/unsealing a resealable opening 207 of the chamber 204 when the top portion 203c of the seal 202 is removed, and (iii) a partition 210 dividing the chamber 204 and configured to separate multiple food products 222 disposed within the chamber 204. In the illustrated embodiment, the sealing member 208 is a double-press zip seal having a tab 209 that provides mechanical leverage for easy opening (e.g., unsealing) of the sealing member 208.

The pouch 200 further includes a valve 214 (e.g., a vacuum valve) configured to facilitate the removal of air from the chamber 204 of the pouch 200. The valve 214 can be a one-way such as a check-valve that that allows air to leave the chamber 204 but not to reenter. To remove air from the chamber 204, the user can simply squeeze and/or press the pouch 200 while the sealing member 208 is closed. An external pressure source (e.g., vacuum source, pump, etc.) can be coupled over the valve 214 and used to remove the air from the chamber 204. At least some of the plastic material of the chamber 104 can be textured to create channels for the air to flow therethrough toward the valve 214 during removal of the air. The pouch 200 can be made of an embossed, waffled, castellated, or other textured plastic material that creates channels for air to be easily removed from the pouch 200. Compared to the pouch 100 described in detail above with reference to FIG. 1, the valve 214 can enable the food products 222 to be positioned within the chamber 204 and at least partially in a sauce 220 with fewer surrounding air pockets. This can increase the surface area of the food products 222 exposed during the sous vide cooking process, and is expected to increase the effectiveness and predictability of the sous vide cooking process.

The valve 214 can include a membrane that permits air to pass from the chamber 204 through the membrane and from the valve 214, but that inhibits non-gaseous contents such as the sauce 220 from exiting the valve 214. For example, the membrane can be made from a water-resistant, or water-proof membrane that allows vapor transmission, such as structured polytetrafluoroethylene (PTFE). Alternatively, a cellulosic material may be used that resists the migration of liquid in the chamber 204, while allowing the flow of vapor. In the illustrated embodiment, the pouch 200 further includes a dam formation 216 configured to inhibit non-gaseous contents such as the sauce 220 and/or other ingredients from exiting through the valve 214 during removal of air via the valve 214. For example, the dam formation 216 can be a seal or weld having a curved shape that at least partially surrounds the valve 214 to block or redirect the sauce 220 from entering the valve 214. That is, the dam formation 216 can be shaped and positioned to increase the distance the sauce 220 must travel to reach the valve 214 while air is being removed from the chamber 204. A lid, such as a heat-sealed lid, can be positioned over the valve 214 to preserve the sauce 220 prior to removal of the top portion 203c of the seal 202 and placement of the food products 222 in the chamber 204. The lid can be formed from a non-permeable material such as a foil or laminate material that does not degrade (e.g., aluminum oxide, ethylene vinylalcohol (EVOH), aluminum foil, etc.). In some embodiments the lid can be adhered to the pouch 200 over the valve 214 during manufacturing and storage to preserve the sterility of the sauce 220 in the pouch 200, and can be removed (e.g., peeled away from the pouch 200) before use.

A sticker 230 (shown schematically in FIG. 2 to avoid obscuring the valve 214) including a QR code and/or product information can be attached to the pouch 200 and removed prior to placement of the food products 222 in the chamber 204 and/or use of the valve 214. Accordingly, the sticker 230 can be positioned over the valve 214 prior to use. Alternatively, the sticker 230 can be attached to another portion of the pouch 200 (e.g., an opposing side) or the information (e.g., a QR code) can be printed directly on the pouch 200.

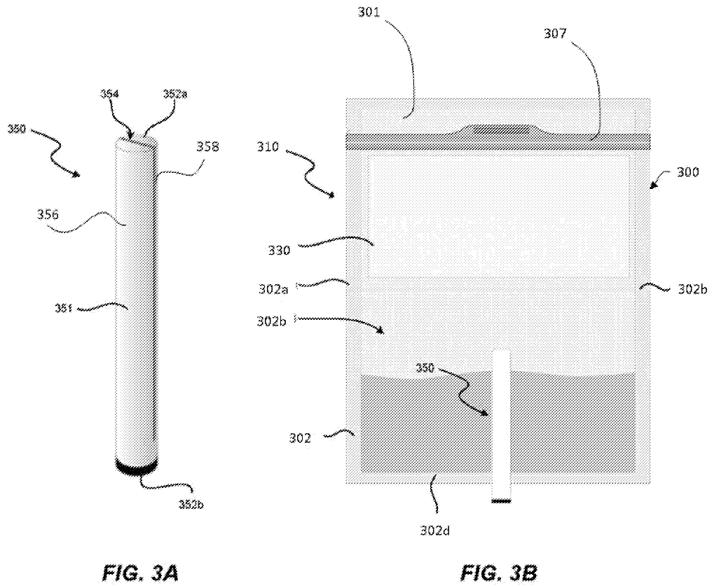

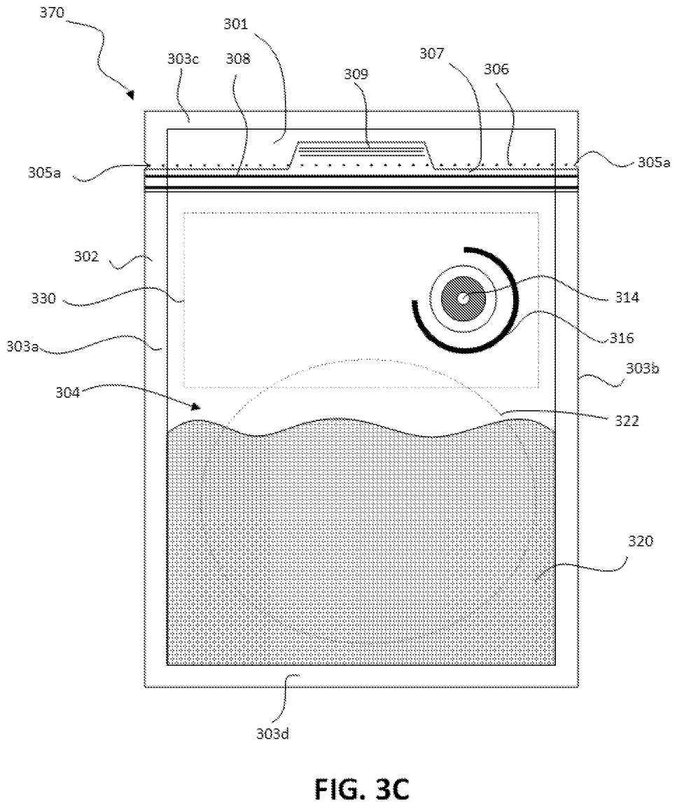

FIG. 3A is a perspective view of an external partition or clip 350 (“clip 350”) in accordance with the present technology. FIG. 3B is a front view of a further example of a pouch 300 shown in FIG. 2 with the clip 350 coupled thereto instead of the partition 200 thereby forming a sous vide assembly 310. Features of the sous vide pouch 300 that are identical or substantially similar to those of the sous vide pouch 200 are provided with a reference number increased by 100. It will be appreciated that the above description of these features in relation to the sous vide pouch 200 are also applicable to the corresponding identical features found in the sous vide pouch 300.

Referring to FIG. 3A, the clip 350 includes a body 351 having a pair of fingers 356, 358 configured to clampingly engage about at least a portion of the plastic material forming the boundary between a first portion 312a and a second portion 312b of the chamber 104, wherein the first and second portions 312a, b are each configured to receive a food product 322 therein. The body of the clip includes a first end portion 352a and a second end portion 352b, and an aperture or slot 354 extending at least partially through the body 351 from the first end portion 352a toward the second end portion 352b. The body 351 can be formed of a material such as plastic or metal. The pair of fingers 356, 358 can be resiliently biased into clamping engagement about at least a portion of the sous vide pouch 200. The resiliency of the arms 356, 358 provide a spring force that urges the fingers 356, 358 of the clip 350 to be biased toward each other and toward the slot 354. While shown with a slot having a generally uniform width over its length, the clip 350 can be formed so that the slot 354 is closed at the first end portion 352a. The second end portion 352b can be formed of or contain a magnetic material.

Referring to FIG. 3B, the pouch 300 is configured similarly to the pouch 100 of FIG. 1 or the pouch 200 of FIG. 2, except there is no partition 110, 210 extending across at least a portion of the pouch 300. The pouch 300 includes several features generally similar to the features of the pouch 100 and pouch 200 described in detail above with reference to FIGS. 1 and 2. For example, the pouch 300 includes an exterior weld or seal 302 having a first side portion 303a, a second side portion 303b, a top portion 303c, and a bottom portion 303d, and defining an interior chamber 304. Likewise, the pouch 300 includes tearable portion 301 including a tear line 306 extending between a first notch 305a and a second notch 305b, a sealing member 308 of a resealable opening 307 configured to be operated by a user for sealing/unsealing the chamber 304 when the top portion 303c of the seal 302 is removed. In the illustrated embodiment, the sealing member 308 is a double-press zip seal having a tab 309 that provides mechanical leverage for easy opening (e.g., unsealing) of the sealing member 308. The pouch 300 further includes a valve 314 (e.g., a vacuum valve—shown in broken line) such as a one-way value configured to facilitate the removal of air from the chamber 304 of the pouch 300. At least some of the plastic material of the chamber 304 may textured to create channels for the air to flow therethrough toward the valve 314 during removal of the air. The texture can include an embossed texture, a waffled texture, or a castellated texture. The valve 314 can include a membrane configured to permit the air within the chamber to pass therethrough and inhibit non-gaseous contents within the chamber exiting via the valve. The sous vide pouch 300 can include a dam formation 316 configured to inhibit the non-gaseous contents exiting the chamber via the valve 314 during removal of the air. The sous vide pouch 300 can include a removable lid for sealing the valve 314.

Referring to FIGS. 3A and 3B together, at least a portion of the pouch 300 (e.g., the bottom portion 303d of the seal 302) can be inserted into the slot 354 of the clip 350 such that the clip 350 forms a boundary between the first portion 312a and the second portion 312b of the chamber 304, wherein the first and second portions 312 are each configured to receive a food product 322 therein. The clip coupling of the clip about the sous vide pouch 300 separates or divides the chamber 304 of the pouch 300 in a generally analogous manner to the partition 110, 210 of pouch 100, 200 respectively. Moreover, the clip 350 can easily be moved laterally relative to the pouch 200 (e.g., toward the first side portion 203a or toward the second side portion 203b of the seal 202) to divide the chamber 204 into two partitions of different sizes.

When the pouch 300 and the clip 350 are inserted into a cooking vessel such as a pot for sous vide cooking, the magnetic second end portion 352b can removably secure the clip 350 to a base of the pot such that the clip 350 maintains the pouch 300 in a generally vertical and submerged position. More than one clip 350 can be used to partition the chamber 304. Alternatively, the clip 350 can be used to maintain the position of the pouch 300 within a cooking instrument (e.g., a pot) without partitioning the chamber 304. For example, one of the first or second side portions 303a, b of the seal 302 can be positioned within the slot 354 of the clip 350 and/or the slot 354 can be formed to be relatively short compared to the chamber 304 (e.g., can receive only the bottom portion 203d of the seal 302). While shown as having only the second end portion 352b formed of or containing a magnetic material, the clip 350 could alternatively be composed entirely or substantially of magnetic material.

In an alternate embodiment of the sous vide assembly 310 described in relation to FIG. 3B, the clip 350 can be used in conjunction with the pouch 100 (FIG. 1) or the pouch 200 (FIG. 2). In one form, the clip 350 may be placed into clamping engagement spaced from the partition 110, 210 thereby defining a further third portion of the chamber 104, 204 located between the clip 350 and the partition 110, 210. For example, the clip 350 could be placed between the partition 110, 112 and the second side portion 103b, 203b, thereby effectively sub-dividing the second portion 112b, 212b into two further portions. These further two portions could then receive further food products. It will be appreciated that multiple clips 350 could be placed in clamping engagement about portions of the sous vide pouch 100, 200 to form more boundaries between portions of the chamber 104, 204.

In one embodiment, a sous vide pouch 370 can be provided which is a modification of sous vide pouch 200 which does not include the partition 210 as shown in FIG. 3C. Features of the sous vide pouch 370 that are identical or substantially similar to those of the sous vide pouch 300 are provided with the same reference number. It will be appreciated that the above description of these features in relation to the sous vide pouch 300 are also applicable to the corresponding identical features found in the sous vide pouch 370.

In this embodiment, the sous vide pouch 370 includes the plastic material defining the chamber 304, a tearable portion 301 inhibiting access to the resealable opening 307 and the valve 314 as described in earlier embodiments. The sauce 320 is contained within the chamber 304 prior to tearing the tearable portion 301. The chamber 304 is configured to receive a food product 322 therein prior to sealing of the resealable opening 307 and removal of the at least some air from within the chamber 304.

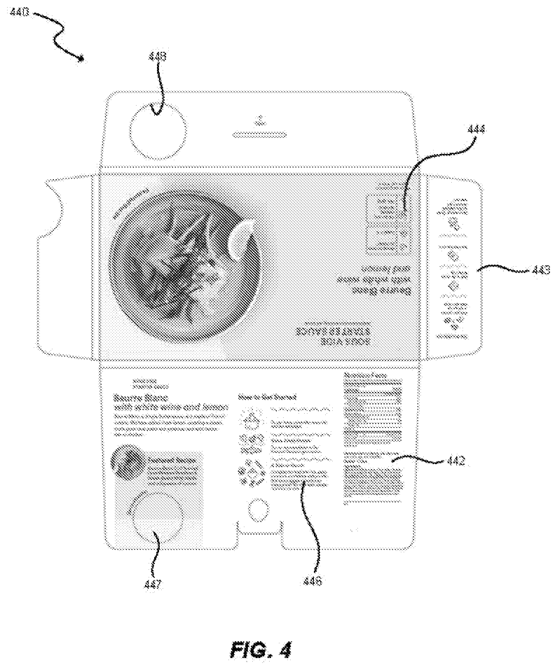

FIG. 4 is a top view of one example of packaging 440 for receiving and securing a pouch (e.g., the pouch 100 of FIG. 1, the pouch 200 of FIG. 2, the pouch 300 of FIG. 3B or the pouch 370 of FIG. 3C). The packaging 440 is shown laid flat in FIG. 4 for the sake of clarity, but is configured to be folded or assembled into a box-like shape for receiving and securing the pouch therein. In general, the packaging 440 can include printed information such as nutrition information 442, cooking instructions 443, flavor and serving size information 444, instructions 446 for using or handling the sous vide pouch, etc. The packaging 440 further can include a QR code 447 linked to a featured recipe. (Of course, the packaging 440 can include different types of information, instructions, directions, etc.) As illustrated, the packaging 440 includes an aperture or hole 448 configured to be aligned with a QR code affixed to or printed on the pouch when the pouch is positioned within the packaging 440. For example, when the pouch 100 (FIG. 1) is positioned within the packaging 440, the hole 448 is positioned to be aligned with the QR code 134 of the sticker 130 such that the QR code 134 is scannable by a user device. The packaging 440 reduces the complexity of tracking sous vide pouches since a corresponding (e.g., linked) QR code does not need to be printed on the packaging 440.

As described above, a sous vide pouch according to the present technology can have a sauce pre-positioned or pre-deposited within a sealed chamber of the pouch. In some embodiments, to cook a food product in the pouch and the sauce, a user need only unseal the chamber (e.g., by tearing away a portion of the pouch), deposit the product in the chamber, remove air from the chamber (e.g., by squeezing, displacement, or using a vacuum pump), and reseal the chamber (e.g., by pressing together a zip-seal member). Often, during cooking of the food product, fluid cooks out of the food product and makes it difficult to maintain a desired consistency for the sauce. In particular, the amount of fluid can vary depending on a user chosen consistency or doneness for the food product—for example, more fluid can be released upon cooking the food product for longer. Consequently, the sauce can be specifically designed to maintain a desired consistency over a wide range of cooking temperatures and cooking conditions. That is, the sauce can have a consistency that is generally independent of—or has reduced dependence on—temperature and dilution.

In some embodiments, to account for dilution and temperature-induced loss of viscosity of the sauce (e.g., as fluid is cooked out of or exuded from the food product), the concentration of thickeners, solids, etc., can be increased during the preparation of the sauce. This can include additional reduction steps or the use of reductions, pastes, concentrates, dried/powdered or other low-moisture ingredients, as well as higher solids contents ingredients so that—after dilution induced by cooking—the sauce has a desired consistency. Additionally, the sauce can comprise a solid gel such that the dilution with exuded cooking liquid softens the gel or crosses the sol-gel concentration in reverse (a gel-sol transition).

For example, the sauce can at least partially comprise a non-Newtonian structured liquid, such as a thixotropic thickener or a fluid gel system. More particularly, the sauce can include many small particles of gel that are specifically designed to resist melting and to absorb many times their weight in liquid while remaining solid. Therefore, as fluid is released during cooking of the food product, the gel particles can absorb or soak up the fluid to maintain the consistency of the sauce. For example, where a sauce is primarily oil or oil-based, fluid released during cooking will generally remain separate from the oil and change—often undesirably—the consistency of the sauce. However, by including gel particles in the sauce, the gel particles can absorb the released fluid to maintain the consistency of the oil sauce and provide a more aesthetic appearance (e.g. with the released fluid binding to the gel particles to then resemble spice particles).

In other embodiments, the sauce can at least partially comprise a lower critical solution temperature (LOST) component such as methyl cellulose (e.g., Methocel). The LOST component is configured to become more viscous as the temperature increases to counteract or counterbalance any loss of viscosity in the sauce as a result of increasing temperatures.

In other embodiments, the sauce can at least partially comprise one or more components that change in response to the liquid cooked out of (e.g., exuded from) the food product. These components can be selected to induce viscosity increases that counteract the viscosity reduction caused by dilution. For example, selected components can cause ion-induced gelation (e.g., alginic acid in the sauce with divalent metals in the exuded liquid), coacervation (e.g., negatively charged gum acacia in the sauce with positively charged gelatin in the exuded liquid), and/or pH-triggered effects. As a particular example of pH-triggered effects, a sauce can be produced at a pH that is too low for efficient operation of chosen thickeners in the sauce. Liquid cooked from the food product is generally at a modest pH, and can therefore raise the pH of the liquid exuded from the food product into a range where the thickeners operate efficiently.

In many cases, an additional important aspect of sauce quality after cooking is the ability of the sauce to cling to the cooked food product and limit spreading. Even a sauce with high viscosity will—over time, under the force of gravity—spread to a thin layer and result in an unappealing product on the plate. Furthermore, emulsified sauces can become unstable upon dilution or heating. Thus, an important quality, regardless of desired viscosity, is the yield stress of the fluid. Accordingly, in some embodiments, the sauce can include thickeners that increase the yield stress of the sauce. Such thickeners can include, for example, thickeners that exhibit a yield stress alone (e.g., xanthan gum), in synergistic combination with other ingredients or components (e.g., locust bean gum and xanthan gum), or by forming a solid gel (e.g., carrageenan with divalent ions) that prevents coalescence by trapping droplets. Emulsions with sufficient dispersed phase content to produce a yield stress (e.g., mayonnaise) can comprise or be included in the sauce.

Additionally, a commonly encountered situation in sous vide cooking is the presence of coagulated albumin proteins on the surface of a meat food product after cooking. These are often globular proteins leeched from the meat food product that coagulate into visible, undesirable masses on the cooked meat food product. Accordingly, in some embodiments, the sauce can include components known to have a stabilizing effect on proteins. For example, by incorporating appropriately selected stabilizing compounds (e.g., protein-complexing polymers), the appearance of undesirable masses on the cooked meat food product can be reduced or even eliminated. Such components could also be employed to prevent undesired coagulation of protein components of the sauce (e.g., dairy) during manufacture, heat processing, or cooking.

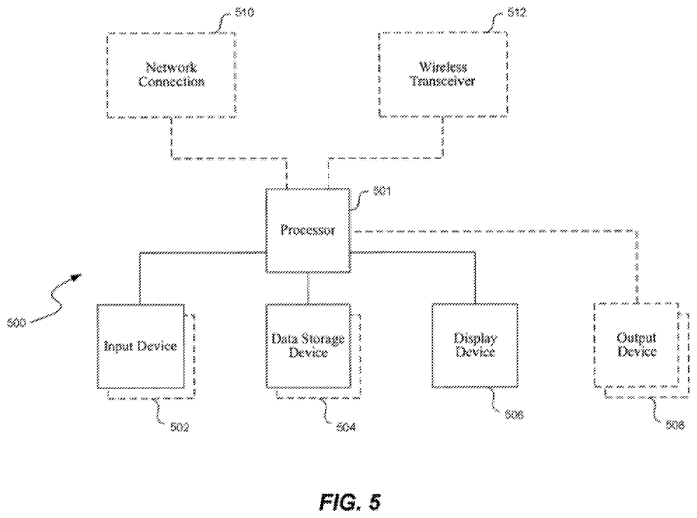

FIG. 5 and the following discussion provide a brief, general description of a suitable computing environment in which aspects of an inventive system for tracking sous vide pouches can be implemented. (Indeed, elements discussed with respect of FIG. 5 can be found in many mobile devices and thus this description applies to aspects of the invention discussed above.) Although not required, aspects and embodiments of the present technology will be described in the general context of computer-executable instructions, such as routines executed by a general-purpose computer, e.g., a server or personal computer. Those skilled in the relevant art will appreciate that the present technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The present technology can be embodied in a special purpose computer or data processor that is specifically programmed, configured or constructed to perform one or more of the computer-executable instructions explained in detail below. Indeed, the term “computer” (and like terms), as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the invention described below may be stored or distributed on computer-readable media, including magnetic and optically readable and removable computer discs, stored as in chips (e.g., EEPROM or flash memory chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 5, one embodiment of the invention employs a user device 500, such as a personal computer or mobile device (e.g., a smart phone), having one or more processors 501 coupled to one or more user input devices 502 and data storage devices 504. The user device 500 is also coupled to at least one output device such as a display device 506 (e.g., a touchscreen display) and one or more optional additional output devices 508 (e.g., a printer (including a 3D printer), speakers, tactile devices, etc.). The user device 500 can be coupled to external computers, such as via a network connection 510, a wireless transceiver 512, and/or or suitable connections.

The user input devices 502 may include a keyboard (e.g., a virtual or touchscreen keyboard) and/or a pointing device such as a mouse. Other input devices 502 are possible such as a microphone, joystick, pen, game pad, scanner, digital camera, video camera, and the like. The data storage devices 504 may include any type of non-transitory computer-readable media that can store data accessible by the user device 500, such as magnetic hard and floppy disk drives, optical disk drives, magnetic cassettes, tape drives, flash memory cards, digital video disks (DVDs), RAMs, ROMs, smart cards, etc. Indeed, any non-transitory medium for storing or transmitting computer-readable instructions and data may be employed, including a connection port to or node on a network such as a local area network (LAN), wide area network (WAN), or the Internet (not shown in FIG. 5).

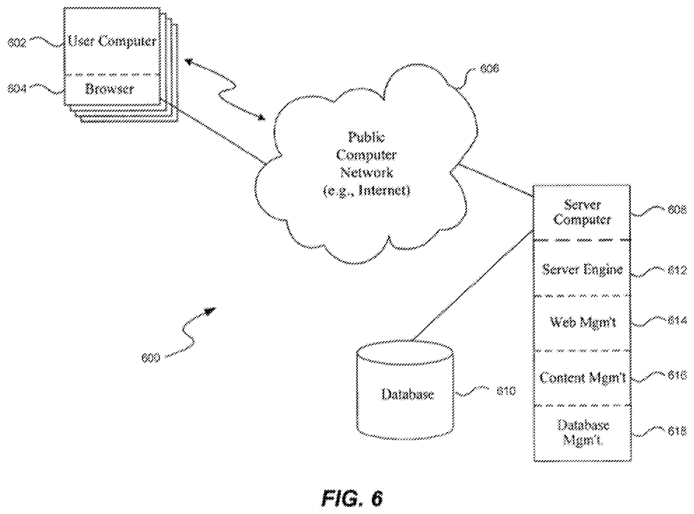

Aspects of the present technology can be practiced in a variety of other computing environments. For example, FIG. 6 illustrates a distributed computing environment or system 600 that includes a web interface and one or more user computers (e.g., mobile devices) 602 in a system 600. In the illustrated embodiment, each of the user computers 602 includes a browser program module 604 that permits the computer to access and exchange data with the Internet 606, including web sites within the World Wide Web portion of the Internet. The user computers 602 may be substantially similar to the user device 600 described in detail above with respect to FIG. 5. The user computers 602 can include other program modules such as an operating system, one or more application programs (e.g., an application that provides recipe information and recommendations as described in detail below), and the like. The user computers 602 may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 608, coupled to the Internet 606, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 610 (or databases), coupled to the server computer(s), stores much of the web pages and content exchanged between the user computers 602. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 608 may include a server engine 612, a web page management component 614, a content management component 616 and a database management component 618. The server engine performs basic processing and operating system level tasks. The web page management component handles creation and display or routing of web pages. Users may access the server computer by means of a URL or an application associated therewith. The content management component handles most of the functions in the embodiments described herein. The database management component includes storage and retrieval tasks with respect to the database, queries to the database, and storage of data.

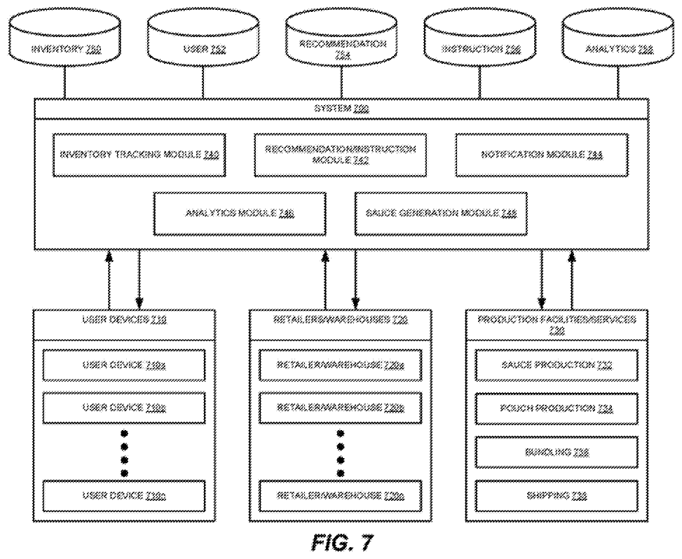

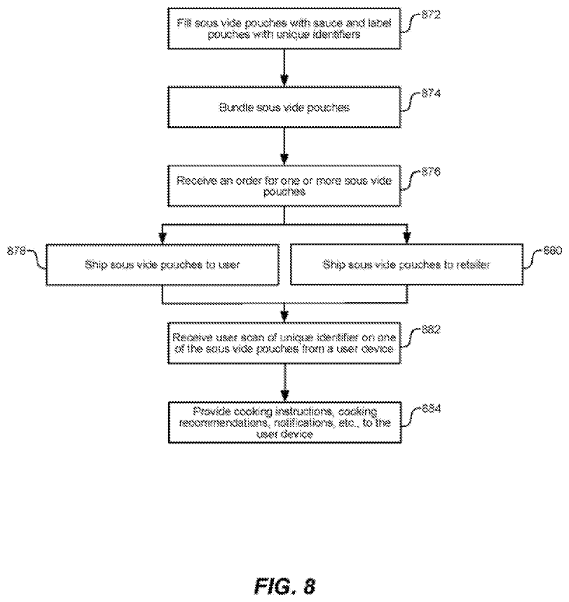

FIG. 7 is a block diagram of a suitable system for tracking sous vide pouches and providing user recommendations and notifications. In general, the system 700 can operate to (i) track sous vide pouches (e.g., the pouches 100, 200, 300, 370 described in detail above), (ii) store and analyze information related to the sous vide pouches, (iii) provide cooking recommendations and instructions to users, (iv) provide notifications and reminders regarding purchased or other sous vide pouches to users or retailers, (v) analyze consumer usage and purchase patterns of sous vide pouches, (vi) cause the production of new sous vide pouches and/or new sauces, etc. While certain aspects of the operation of the system 700 are described in the context of sous vide pouches, one skilled in the art will understand that the system 700 is configured to operate with respect to many different trackable items (e.g., kitchen items). Moreover, the system 700 can operate on or among the user devices 500 and/or other devices, systems, etc., and it may be distributed among such devices and, for example, the server computer(s) 608, as described in detail above with reference to FIGS. 5 and 6.

The system 700 is configured to track an inventory of sous vide pouches by sending and/or receiving data from (i) multiple user devices 710 (e.g., via an application running on the user devices 710), from (ii) multiple third-party retailers or warehouses 720 (“retailers 720”) and/or (iii) production facilities and/or services 730 (“production facilities 730”). For example, the system 700 can send and/or receive data from mobile devices, local computers, server computers, etc., at or associated with the retailers 720 and/or production facilities 730. As described in detail above, the sous vide pouches have QR codes or other unique identifiers (e.g., RFID chips or tags) affixed to or inscribed thereon for storing or linking to information about the sous vide pouches. Accordingly, the sous vide pouches can be individually scannable at or by the user devices 710, the retailers 720, and/or the production facilities 730 to provide information about or associated with the sous vide pouches.

In the illustrated embodiment, the production facilities 730 includes sauce production facilities and/or services 732 (“sauce production facilities 732”) for producing sauces or other flavorings for packing in sous vide pouches, and pouch production facilities and/or services 734 (“pouch production facilities 734”) for manufacturing or otherwise providing the sous vide pouches and filling the sous pouches with sauce. In some embodiments, the sauce production facilities 732 can produce sauces in lots or batches configured to fill a specific number of sous vide pouches (e.g., 100, 1000, more than 1000, etc.). The pouch production facilities 734 can provide each sous vide pouch with a QR code including data about the batch number and type, best by date, place of production, production date, pack date, etc. In some embodiments (e.g., a high-fidelity embodiment), each sous vide pouch is provided with a unique QR code. Alternatively (e.g., a low-fidelity embodiment), each sous vide pouch in a particular batch is provided with the same QR code such that the sous vide pouches are traceable by the batch rather than individually.

The production facilities 730 can further include bundling facilities and/or services 736 (“bundling facilities 736”) for bundling sous vide pouches into bundles to be sold together, and shipping facilities and/or services 738 (“shipping facilities 738”) for shipping the bundles and/or individual sous vide pouches to the retailers 720 or directly to users associated with the user devices 710. In some embodiments, sous vide pouches can be bundled into bundles of four each having different sauces (e.g., four different classic French sauces), or into bundles having multiple ones of the same sauce. Some or all of the production facilities and/or services 730 can be fully automated. For example, producing sauces and sous vide pouches as well as bundling and shipping prepared sous vide pouches can be carried out robotically or automatically with little or minimal human intervention.

In the illustrated embodiment, the system 700 includes an inventory tracking module 740, a recommendation and/or instruction module 742 (“recommendation module 742”), a notification module 744, an analytics module 746, and a sauce generation module 748. The system 700 reads, stores, and/or accesses data from an inventory database 750, a user database 752, a recommendation database 754, an instruction database 756, and an analytics database 758. Other databases, not shown, can be connected to the system 700. Also, while the databases are shown separately, the databases can be integrated into fewer databases (e.g., a single database).

The inventory tracking module 740 is configured to track and update information about a location of or party associated with the sous vide pouches. In some embodiments, the inventory tracking module 740 can receive information from the bundling facilities 736 indicating that certain sous vide pouches have been bundled for sale together. Similarly, the inventory tracking module 740 can receive information from the shipping facilities 738 indicating that certain sous vide pouches have been purchased by and/or shipped to particular (i) users associated with the user devices 710 or (ii) ones of the retailers 720. The system 700 can then update the inventory database 750 to reflect the location information and/or the user database 752 to reflect that a particular user has purchased the sous vide pouches. That is, the system 700 can receive information about the movements of particular sous vide pouches as they are purchased and shipped to users or retailers.

Similarly, the inventory tracking module 740 can receive information about the location of a sous vide pouch if a user scans the QR code (or other identifier associated therewith) on a sous vide pouch they have purchased or otherwise received. For example, after a user purchases a sous vide pouch from one of the retailers 720, a user can scan the QR code of the sous vide pouch to get recipe information and/or cooking instruction information (e.g., via an application running on an associated one of the user devices 710), as described in detail below. The inventory tracking module 740 can then update the inventory database 750 and the user database 752 to reflect that the purchased sous vide pouch is associated with that user. The system 700 can also determine that a scanned sous vide pouch is part of a bundle, and the inventory tracking module 740 can update the information in the inventory database 750 for the sous vide pouches packaged in the same bundle as the scanned sous vide pouch (e.g., indicating that each was purchased by the user even if not all have been scanned yet). Where a sous vide pouch is purchased from one of the retailers 720, the inventory tracking module 740 can further determine which one of the retailers 720 sold the sous vide pouch by comparing the unique QR code to the information stored in the inventory database 750 (e.g., stored when the sous vide pouch was shipped to the retailer). Where the QR codes are unique only to a certain batch of sous vide pouches (e.g., a low-fidelity embodiment), the system 700 can still determine which retailer sold a particular sous vide pouch if the batch was produced for and/or shipped to only a single retailer. In some embodiments, the system 700 can automatically determine when a threshold or predetermined number of pouches have been sold by a particular one of the retailers 720, and can cause the production facilities 730 to ship additional pouches to the retailer.

The recommendation module 742 is configured to provide cooking recommendations to the user devices 710. For example, after purchasing one or a bundle of sous vide pouches, a user can scan the QR code on a sous vide pouch they wish to use to receive cooking instructions and recommendations (e.g., via an application running on an associated one of the user devices 710). In some embodiments, the recommendation module 742 can access product information (e.g., sauce type) stored in the inventory database 750 and/or historical user data stored in the user database 752 (e.g., historical information about food choices, previous sauce and food product combinations for the user, etc.) to generate recommendations for food products to cook in the sous vide pouch. For example, if the user has previously chosen chicken for use with teriyaki sauces, the recommendation module 742 may recommend cooking chicken if a sous vide pouch having teriyaki sauce is scanned.

Similarly, the recommendation module 742 can generate cooking recommendations based on a determined location of the user. For example, as described in detail above, the inventory tracking module 740 can be configured to determine the general location of the user based on which one of the retailers 720 the user purchased a sous vide pouch from. For example, the system 700 can generate a location based on GPS or other data associated with the user devices 710. Based on the location, the recommendation module 742 could recommend recipes with local ingredients, like more frequently recommending salmon to users purchasing sous vide pouches in Alaska or the Northwest, while more frequently recommending shellfish to users purchasing sous vide pouches along the Gulf Coast. The recommendation module 742 can also generate cooking recommendations based on a determined availability of particular food products. For example, the recommendation module 742 can access information from the recommendation database 754 about the current stock, availability, and/or price of different food products at the retailers 720 or other grocery stores, and filter potential recommendations based on availability or price.

Alternatively or additionally, the recommendation module 742 can be configured to receive user inputs from the user devices 710 for providing recommendations. For example, a user can provide information about desired (i) characteristics of a food product (e.g., savory, sweet, salty, crunchy, etc.), (ii) cooking time, (iii) calorie or other nutritional characteristics, etc., via an application running on an associated one of the user devices 710. The recommendation module 742 can then receive the information and compare it to information stored in the recommendation database 754 to recommend a particular food product. The system 700 can then send the recommendation to the user device 710.

The recommendation module 742 is further configured to receive user inputs from the user devices 710 and to provide cooking instructions to the user devices 710. For example, a user can provide information about a desired (i) food product to be cooked, (ii) consistency of the food product, (iii) doneness of the food product, and/or (iv) texture of the food product via an application running on an associated one of the user devices 710. The recommendation module 742 can then receive the information and compare it to information stored in the instruction database 756 to generate cooking instructions for the food product. The system 700 can then send the cooking instructions to the user device 710. The cooking instructions can be sent directly or via one of the user devices 710 to a sous vide cooking device configured to cook the particular food product based on the cooking instructions.

In some embodiments, the recommendation module 742 is configured to provide cooking recommendations and/or cooking instructions for side dishes to the user devices 710, as in any of the embodiments described in detail above.

The notification module 744 is configured to generate and send notifications to the user devices 710 and/or the retailers 720. For example, once a user is associated with a sous vide pouch (e.g., after purchasing directly from the production facilities 730 or scanning the QR code of the sous vide pouch after purchasing from one of the retailers 720), the notification module 744 can generate and send notifications to a user device 710 associated with the user. The notifications can include reminders about upcoming best-by or expiration dates, or alerts about recalls of certain sous vide pouches. In some embodiments, the system 700 can determine that the user is running low on sous vide pouches (e.g., has scanned three of the four pouches in a bundle) and provide a corresponding reminder or prompt to purchase additional sous vide pouches. Similarly, the system 700 can determine that the user has used most or all of a certain sauce (e.g., has scanned all the pouches having teriyaki sauce in a bundle) and provide a corresponding prompt to purchase one or a bundle of pouches having that sauce. Moreover, the system 700 can determine that particular sauces are currently popular based on data received and stored in the inventory database 750 (e.g., global or multi-user purchase or QR-scan data), and provide a corresponding prompt to purchase one or a bundle of pouches having that sauce. Likewise, the system 700 can be configured to provide prompts to purchase one or a bundle of pouches based on historical usage data for a particular user (e.g., past purchases, cooking selections, etc.) stored in the user database 752.

In some embodiments, once one of the retailers 720 is associated with a sous vide pouch (e.g., after purchasing the sous vide pouch from the production facilities 730), the notification module 744 can generate and send notifications to one or more computing devices associated with the retailer 720. For example, the notifications can include reminders about upcoming best-by or expiration dates, or alerts about product recalls. Similarly, the notifications can include information about currently popular sauces, user trends, etc., or reminders or prompts to purchase additional sous vide pouches.

The analytics module 746 is configured to analyze (i) information provided from the user devices 710, the retailers 720, and/or the production facilities 730, (ii) inventory information stored in the inventory database 750, (iii) user information stored in the user database 752, (iv) historical information stored in the analytics database 758, and/or (v) other information stored in any one or more of the databases 750-758 to, for example, determine overall purchase and consumption information and patterns for the sous vide pouches and particular sauces or flavors. For example, the analytics module 758 could determine that particular sauces are more popular (e.g., more often scanned) in certain geographic regions or more frequently purchased from a particular one of the retailers 720. Such information could be stored in the recommendation database 754 and used to provide recommendations to users or to provide notifications or sale offers to particular retailers 720. That is, specific user recommendations, retailer notifications, etc., can be based on global data that is collected and analyzed by the system 700.

The sauce generation module 748 is configured to generate and send instructions to the production facilities 730 for cooking new batches of sauce for inclusion in the sous vide pouches. For example, the sauce generation module 748 can generate instructions for cooking new batches of sauce based on information generated by the analytics module 746. The analytics module 746 could determine that a first sauce included in a bundle of pouches is most frequently cooked last by users, or that a second sauce included in the bundle is frequently cooked first by users. In such embodiments, the sauce generation module 748 could instruct the bundling facilities 736 to provide bundles without the first sauce, with multiple ones of the first sauce, etc. Likewise, if consumer purchasing and/or usage information provided by the analytics module 746 indicates that a particular sauce is too salty, the sauce generation module 748 can instruct the sauce production facilities 732 to reduce the salt content of that sauce. In some embodiments, the sauce generation module 748 can receive orders from the retailers 720 for producing more of a certain sauce—and can instruct the production facilities 730 accordingly.

The present technology allows for individual sous vide pouches to be tracked from production of the sous vide pouch to its ultimate use by a consumer in cooking a food product. In particular, users and/or retailers can scan a QR code on a sous vide pouch via an application running on a mobile device to receive cooking instructions, cooking recommendations, or other information. The act of scanning the QR code provides useful information about a user associated with the sous vide pouch. As described above, by uniquely identifying and tracking sous vide pouches, the present technology allows for relevant recommendations and notifications to be provided to users and retailers alike. More particularly, FIG. 8 is a flow diagram of a process or method 870 for producing and tracking sous vide pouches in accordance with an embodiment of the present technology. For the sake of illustration, some features of the process 870 will be described in the context of the embodiment shown in FIG. 7.

At block 872, the method 870 includes filling sous vide pouches with sauce and labeling the pouches with unique identifiers. For example, the sauce generation module 748 can send instructions to the sauce production facilities 732 to produce a certain quantity and type of sauce (e.g., a batch of sauce). The pouch production facilities 734 can then produce and fill sous vide pouches with the sauce and can label each pouch with a unique identifier such as a QR code. At block 874, the sous vide pouches can optionally be bundled together into salable units of greater than one sous vide pouch, and potentially including multiple flavors of sauce. In some embodiments, the QR code of each pouch can be scanned at block 872 or block 874 to update the inventory database 750 with information about the newly produced sous vide pouches (e.g., sauce type, batch size, production date, best-by-date, bundle information, etc.).

At block 876, the method 870 includes receiving an order for one or more sous vide pouches. The order can originate from an end consumer or user (e.g., from one of the user devices 710) or from a third-party retailer (e.g., from one of the retailers 720). Accordingly, at blocks 878 and 880, the ordered sous vide pouches are shipped to the consumer or the retailer, respectively. Before shipping the ordered sous vide pouches, the pouches can be scanned (e.g., by the shipping facilities 738) to update the inventory database 750 and/or the user database 752 with information about the purchaser and/or sale.

At block 882, the method 870 includes receiving a user scan of the QR code on one of the purchased and shipped sous vide pouches from a user device (e.g., via an application running on one of the user devices 710). The user can be the direct purchaser of the sous vide pouch (block 878) or have purchased from the retailer (block 880). At block 884, the method 870 includes providing cooking instructions, cooking recommendations, notifications, etc., to the user device as described in detail above.

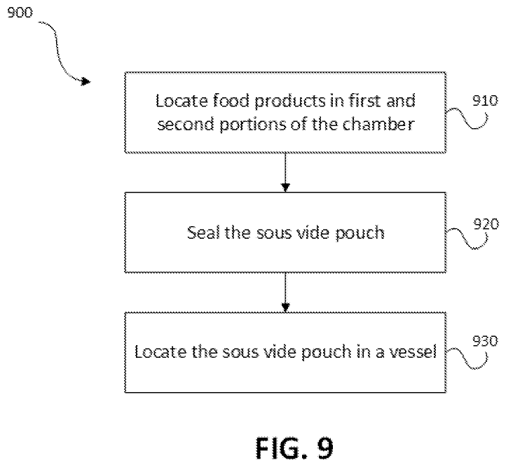

Referring to FIG. 9, there is shown a flow diagram of an example of a suitable process or method 900 for cooking food products using the sous vide pouch 100 of FIG. 1 or the sous vide pouch 200 of FIG. 2. At step 910, the method 900 includes locating the food products 122 in the first and second portions 112, 212 of the chamber 104, 204. At step 920, the method includes sealing the sous vide pouch. This may be performed using a sealing machine or using a resealable seal. At step 930, the method 900 includes locating the sous vide pouch 100, 200 in a cooking vessel for sous vide cooking.

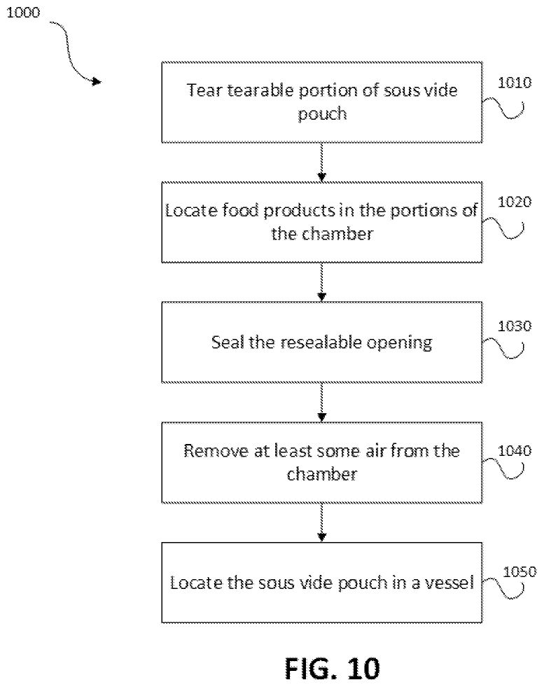

Referring to FIG. 10, there is shown a flow diagram of an example of a suitable process or method 1000 for cooking food products using the embodiment of the sous vide pouch 370 of FIG. 3C. At step 1010, the method 1000 includes tearing the tearable portion 301 of the sous vide pouch 370. The resealable opening 307 may be sealed after removal of the tearable portion such that the method 1000 may include unsealing the sealable opening 307. At step 1020, the method 1000 includes locating one or more food products 322 in the first and second portions 312a, b of the chamber 304. At step 1030, the method 1000 includes sealing the resealable opening 307. At step 1040 the method 1000 includes removing at least some air from the chamber via the valve 314. At step 1050, the method 1000 includes locating the sous vide pouch 370 in a cooking vessel for sous vide cooking.

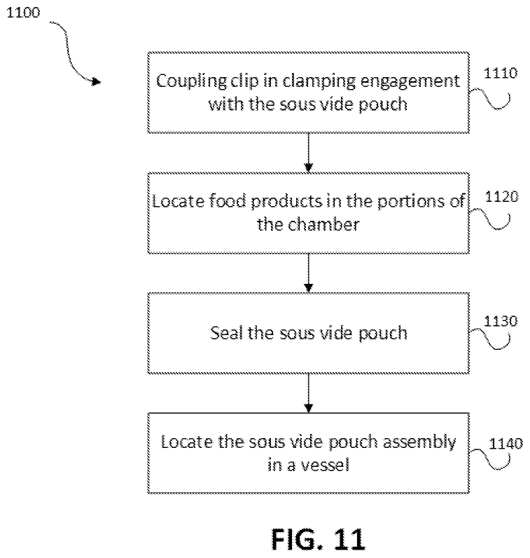

Referring to FIG. 11, there is shown a flow diagram of an example of a suitable process or method 1100 for cooking food products using the sous vide pouch assembly 310. At step 1110, the method 1100 includes coupling the clip 350 in clamping engagement with the sous vide pouch 300. At step 1130, the method 1100 includes locating the food products 322 in the first and second portions 312a, b of the chamber 304. At step 1130, the method 1100 includes sealing the sous vide pouch 300. This may be performed using a sealing machine or using a resealable seal. At step 1140 the method 1100 includes removing at least some air from the chamber via the valve 314. At step 1150, the method 1000 includes locating the sous vide pouch assembly 310 in a cooking vessel for sous vide cooking.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

1. A sous vide pouch, comprising:
a plastic material having a sealed portion extending at least partially around a perimeter of the plastic material and defining a chamber; and
a partition extending within at least a portion of the chamber forming a boundary between a first portion and a second portion of the chamber, wherein the first and second portions are each configured to receive a food product therein.

2. The sous vide pouch according to claim 1, comprising a tearable portion and a resealable opening of the chamber, wherein the resealable opening of the chamber is accessible by tearing of the tearable portion.

3. The sous vide pouch according to claim 2, wherein the chamber contains a sauce prior to the tearing of the tearable portion.

4. The sous vide pouch according to claim 3, wherein the sauce includes at least one of:
a liquid; and
a gel.

5. The sous vide pouch according to any one of claims 1 to 4, wherein the partition is:
a weld between opposing wall portions of the chamber; or
a seal between the opposing wall portions of the chamber.

6. The sous vide pouch according to claim 5, wherein the seal is an adhesive seal.

7. The sous vide pouch according to any one of claims 1 to 6, wherein the partition is frangible to remove the boundary between the first and second portions.

8. The sous vide pouch according to any one of claims 1 to 7, comprising a valve to facilitate removal of air from the chamber.

9. The sous vide pouch according to claim 8, wherein the valve is a one-way valve.

10. The sous vide pouch according to claim 8 or 9, wherein at least some of the plastic material of the chamber is textured to create channels for the air to flow therethrough toward the valve during removal of the air.

11. The sous vide pouch according to claim 10, wherein the at least some of the plastic material of the chamber that is textured comprises:
an embossed texture;
a waffled texture; or
a castellated texture.

12. The sous vide pouch according to any one of claims 8 to 11, wherein the valve includes a membrane configured to permit the air within the chamber to pass therethrough and inhibit non-gaseous contents within the chamber exiting via the valve.

13. The sous vide pouch according to any one of claims 8 to 12, wherein the sous vide pouch includes a dam formation configured to inhibit the non-gaseous contents exiting the chamber via the valve during removal of the air.

14. The sous vide pouch according to any one of claims 8 to 13, comprising a removable lid for sealing the valve.

15. The sous vide pouch according to any one of claims 1 to 14, wherein a machine-readable code is printed or applied to an exterior surface of the sous vide pouch, wherein the machine-readable code is indicative of at least one of:
a type of contents within the chamber;
a batch number of the contents within the chamber;
a manufacture date of the contents within the chamber; and
a best-by date of the contents within the chamber.

16. A sous vide pouch assembly, comprising:
a sous vide pouch comprising a plastic material having a seal portion extending at least partially around a perimeter of the plastic material and defining a chamber; and
a clip including a pair of fingers configured to clampingly engage about at least a portion of the plastic material forming a boundary between a first portion and a second portion of the chamber, wherein the first and second portions are each configured to receive a food product therein.

17. The sous vide pouch assembly according to claim 16, wherein the pair of fingers are resiliently biased into clamping engagement about the at least a portion of the plastic material.

18. The sous vide pouch assembly according to claim 16 or 17, wherein the clip includes a magnetic material for removably securing the sous vide pouch assembly to a base of a cooking vessel.

19. The sous vide pouch assembly according to any one of claims 16 to 18, wherein the sous vide pouch comprises a tearable portion and a resealable opening of the chamber, wherein the resealable opening of the chamber is accessible by tearing of the tearable portion.

20. The sous vide pouch assembly according to claim 19, wherein the chamber contains a sauce prior to the tearing of the tearable portion.

21. The sous vide pouch assembly according to claim 20, wherein the sauce includes at least one of:
a liquid; and
a gel.

22. The sous vide pouch assembly according to claim 21, wherein the sous vide pouch comprises a valve to facilitate removal of air from the chamber.

23. The sous vide pouch assembly according to claim 22, wherein the valve is a one-way valve.

24. The sous vide pouch assembly according to claim 22 or 23, wherein at least some of the plastic material of the chamber is textured to create channels for the air to flow therethrough toward the valve during removal of the air.

25. The sous vide pouch assembly according to claim 24, wherein the at least some of the plastic material of the chamber that is textured comprises:
an embossed texture;
a waffled texture; or
a castellated texture.

26. The sous vide pouch assembly according to any one of claims 22 to 25, wherein the valve includes a membrane configured to permit the air within the chamber to pass therethrough and inhibit non-gaseous contents within the chamber exiting via the valve.

27. The sous vide pouch assembly according to any one of claims 22 to 26, wherein the sous vide pouch includes a dam formation configured to inhibit the non-gaseous contents exiting the chamber via the valve during removal of the air.

28. The sous vide pouch assembly according to any one of claims 22 to 27, wherein the sous vide pouch includes a removable lid for sealing the valve.

29. The sous vide pouch according to any one of claims 16 to 28, wherein a machine-readable code is printed or applied to an exterior surface of the sous vide pouch, wherein the machine-readable code is indicative of at least one of:
a type of contents within the chamber;
a batch number of the contents within the chamber;
a manufacture date of the contents within the chamber; and
a best-by date of the contents within the chamber.

30. The sous vide pouch assembly according to any one of claims 16 to 29, wherein the sous vide pouch includes a partition extending within at least a portion of the chamber forming a further boundary and a further portion of the chamber configured to receive a further food product therein.

31. The sous vide pouch assembly according to claim 30, wherein the partition is:
a weld between opposing wall portions of the chamber; or
a seal between the opposing wall portions of the chamber.

32. The sous vide pouch assembly according to claim 31, wherein the seal is an adhesive seal.

33. The sous vide pouch assembly according to any one of claims 30 to 32, wherein the partition is frangible to remove the further boundary.

34. A sous vide pouch, comprising
a plastic material having a seal portion extending at least partially around a perimeter of the plastic material and defining a chamber, wherein the chamber includes a resealable opening;
a tearable portion inhibiting access to the resealable opening; and
a valve to facilitate removal of at least some air from the chamber;
wherein a sauce is contained within the chamber prior to tearing of the tearable portion; and
wherein the chamber is configured to receive a food product therein prior to sealing of the resealable opening and removal of the at least some air from within the chamber.

35. The sous vide pouch according to claim 34, wherein the valve is a one-way valve.

36. The sous vide pouch according to claim 34 or 35, wherein at least some of the plastic material of the chamber is textured to create channels for the air to flow therethrough toward the valve during removal of the air.

37. The sous vide pouch according to claim 36, wherein the at least some of the plastic material of the chamber that is textured comprises:
an embossed texture;
a waffled texture; or
a castellated texture.

38. The sous vide pouch according to any one of claims 34 to 37, wherein the valve includes a membrane configured to permit the air within the chamber to pass therethrough and inhibit non-gaseous contents within the chamber exiting via the valve.

39. The sous vide pouch according to any one of claims 34 to 38, wherein the sous vide pouch includes a dam formation configured to inhibit the non-gaseous contents exiting the chamber via the valve during removal of the air.

40. The sous vide pouch according to any one of claims 34 to 39, comprising a removable lid for sealing the valve.

41. The sous vide pouch according to any one of claims 34 to 40, wherein a machine-readable code is printed or applied to an exterior surface of the sous vide pouch, wherein the machine-readable code is indicative of at least one of:
a type of contents within the chamber;
a batch number of the contents within the chamber;
a manufacture date of the contents within the chamber; and
a best-by date of the contents within the chamber.

42. A method of cooking using a sous vide pouch configured according to any one of claims 1 to 15, comprising:
locating the food products in the first and second portions of the chamber;
sealing the sous vide pouch; and
locating the sous vide pouch in a cooking vessel.

43. A method of cooking using a sous vide pouch assembly configured according to any one of claims 16 to 33, comprising:
coupling the clip in clamping engagement with the sous vide pouch;
locating the food products in the first and second portions of the chamber;
sealing the sous vide pouch; and
locating the sous vide pouch in a cooking vessel.

44. A method of cooking using a sous vide pouch configured according to any one of claims 34 to 41, comprising:
tearing the tearable portion;
locating the food product in the chamber;
sealing the resealable opening;
removing at least some air from the chamber via the valve; and
locating the sous vide pouch in a cooking vessel.

45. A system for tracking sous vide pouches, comprising:
at least one processor; and
at least one non-transitory processor-readable medium storing processor-executable instructions that, when executed by the at least one processor, cause the at least one processor to:
receive data from at least one production facility about the sous vide pouches, the data including information about at least one of a type of sauce contained within the sous vide pouches, a retailer associated with the sous vide pouches, a best-by-date of the sous vide pouches, and a bundle associated with the sous vide pouches;
receive, from at least one user device, a request for cooking instructions and/or recipe information associated with at least one of the sous vide pouches; and
provide the cooking instructions and/or the recipe information to the at least one user device.

46. The system according to claim 45, wherein each sous vide pouch is configured according to any one of claims 1 to 15 and 34 to 41.

47. The system according to claim 45, wherein each sous vide pouch is part of a sous vide assembly according to any one of claims 16 to 33.
